(19) United States
(12) Patent Application Publication
(10) Pub. No.: US 2024/0078336 A1
(43) Pub. Date: Mar. 7, 2024

(54) ANNOTATION INJECTOR FOR PROTECTING PERSONAL INFORMATION, CONFIDENTIAL INFORMATION, HIGHLY CONFIDENTIAL INFORMATION, AND OTHERWISE SENSITIVE DATA

(71) Applicant: JPMorgan Chase Bank, N.A., New York, NY (US)

(72) Inventors: Benjamin H. SANSOM, Little Elm, TX (US); Christopher C. MORRIS, Reading, PA (US); James Alexander HUTTON, Wilmington, DE (US); Ellen S. DEWITT, Columbus, OH (US)

(73) Assignee: JPMorgan Chase Bank, N.A., New York, NY (US)

(21) Appl. No.: 18/227,501

(22) Filed: Jul. 28, 2023

Related U.S. Application Data
(60) Provisional application No. 63/404,066, filed on Sep. 6, 2022.

(51) Int. Cl. G06F 21/62; G06F 8/77

(52) U.S. Cl. CPC G06F 21/6245; G06F 8/77; G06Q 50/265

(57) ABSTRACT

Various methods, apparatuses/systems, and media for automatically protecting sensitive information data entering application logs, events, metrics, traces, or other outputs are disclosed. A processor receives source code associated with an application being developed; parses the source code and identifies variables or fields in the source code that include sensitive information data; applies artificial intelligence or machine learning algorithm to the source code to automatically identify variables that contain the sensitive information data based on the identified variables or fields and annotating accordingly. Each annotation is a hint that data associated with corresponding annotation is confidential and sensitive information that should not be published, logged, or printed. The processor automatically updates the source code with the annotation; and automatically updates the database or the code editor with the updated source code so that changes made to the source code would be permanently implemented during compiling and deploying of the application.

### CROSS-REFERENCE TO RELATED APPLICATIONS

This application claims the benefit of priority from U.S. Provisional Patent Application No. 63/404,066, filed Sep. 6, 2022, which is herein incorporated by reference in its entirety.

### TECHNICAL FIELD

This disclosure generally relates to data processing, and, more particularly, to methods and apparatuses for implementing a language and platform agnostic automated annotation injector module for protecting personal information, confidential information, highly confidential information, and otherwise sensitive data from entering application logs, events, metrics, traces, or other outputs.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Today, a wide variety of business functions are commonly supported by software applications and tools, i.e., business intelligence tools. For instance, software has been directed to data monitoring, performance analysis, project tracking, and competitive analysis, to name but a few. Applications can write personal information data when logging or otherwise exposing data for telemetry. Solutions may exist for finding data in the logs, however at that point the application already published the data. This creates risk and significant effort to remediate. Solutions exist for detection, but this does not prevent the problem. Conventional tools do not inject rules before the application is compiled, thereby fail to prevent the above-described problem.

### SUMMARY

The present disclosure, through one or more of its various aspects, embodiments, and/or specific features or sub-components, provides, among other features, various systems, servers, devices, methods, media, programs, and platforms for implementing a platform and language agnostic automated annotation injector module for automatically injecting rules before an application is being compiled for protecting sensitive data that may include personal information (PI), personally identifiable information (PII), confidential information (CI), highly confidential information (HCl), and other sensitive data from entering application logs, events, metrics, traces, or other outputs, but the disclosure is not limited thereto.

According to exemplary embodiments, a method for automatically protecting sensitive information from being published, logged, or printed during an application compilation and/or deployment by utilizing one or more processors along with allocated memory is disclosed. The method may include: receiving source code associated with an application being developed from a database or code editor; parsing the source code; identifying, in response to parsing, variables or fields in the source code that may include sensitive information data; applying artificial intelligence or machine learning algorithm to the source code to automatically identify variables that contain the sensitive information data based on the identified variables or fields in the source code and annotating accordingly, wherein each annotation is a hint that data associated with corresponding annotation is confidential and sensitive information that should not be published, logged, or printed; automatically updating the source code with the annotation; and automatically updating the database or code editor with the updated source code so that changes made to the source code would be permanently implemented during compiling and deploying of the application.

According to exemplary embodiments, the sensitive information data may include one or more of the following data name, address, phone number, social security number, credit card information, bank account, email address, customer spending data, customer health data, automated teller machine usage data, customer location data, trading positions, etc., but the disclosure is not limited thereto. For example, the sensitive information data may include any sensitive data based on rules/algorithms. The sensitive information data may also include data an organization does not want to serialize in telemetry outputs, like logs, but the disclosure is not limited thereto. In addition to customer related sensitive information data, the sensitive information data may also include any sensitive data related to employee or company data, but the disclosure is not limited thereto.

According to exemplary embodiments, in automatically annotating the identified sensitive information data, the method may further include: marking a field or data element in the source code; and stating that the marked field or the data element should not be written in plain text or any human readable format prior to or during compilation and/or deployment of the application, but the disclosure is not limited thereto.

According to exemplary embodiments, in parsing the source code, the method may further include: checking the way fields are declared in the source code.

According to exemplary embodiments, in identifying sensitive information data, the method may further include: applying the artificial intelligence or machine learning algorithm to identify words, phrases, and patterns from the source code that are known to be associated with confidential and sensitive information, but the disclosure is not limited thereto. For example, machine learning models can be generated by applying the artificial intelligence or machine learning algorithm to identify words, phrases, and patterns from the source code and the automated annotation injector module may be configured to implement pattern matching algorithms, dictionaries, e.g., corpora and lexical resources, etc., and natural language processing libraries to train the models.

According to exemplary embodiments, in automatically annotating the identified sensitive information data, the method may further include: masking, hashing, encrypting, not publishing the identified sensitive information data or otherwise making the identified sensitive information unreadable to humans, but the disclosure is not limited thereto.

According to exemplary embodiments, the method may further include: parsing the source code to identify a field declaration; comparing the identified field declaration with a list of prestored declarations known to be associated with confidential and sensitive information data; and outputting a result of comparison.

According to exemplary embodiments, the method may further include: determining that the result of comparison is a value that is less than a configurable threshold value; and determining that the identified field declaration does not include confidential and sensitive information data based on determining that the result of comparison is a value that is less than the configurable threshold value.

According to exemplary embodiments, the method may further include: determining that the result of comparison is a value that is equal to or more than the configurable threshold value; determining that the identified field declaration includes confidential and sensitive information data based on determining that the result of comparison is a value that is equal to or more than the configurable threshold value; and automatically annotating the identified field declaration as the identified sensitive information data.

According to exemplary embodiments, a system for automatically protecting sensitive information from being published, logged, or printed during an application compilation and/or deployment is disclosed. The system may include: a processor; and a memory operatively connected to the processor via a communication interface, the memory storing computer readable instructions, when executed, may cause the processor to: receive source code associated with an application being developed from a database or code editor; parse the source code; identify, in response to parsing, variables or fields in the source code that may include sensitive information data; apply artificial intelligence or machine learning algorithm to the source code to automatically identify variables that contain the sensitive information data based on the identified variables or fields and annotate accordingly, wherein each annotation is a hint that data associated with corresponding annotation is confidential and sensitive information that should not be published, logged, or printed; automatically update the source code with the annotation; and automatically update the database or code editor with the updated source code so that changes made to the source code would be permanently implemented during compiling and deploying of the application.

According to exemplary embodiments, wherein in automatically annotating the identified sensitive information data, and the processor may be further configured to: mark a field or data element in the source code; and state that the marked field or the data element should not be written in plain text or any human readable format prior to or during compilation and/or deployment of the application, but the disclosure is not limited thereto.

According to exemplary embodiments, wherein in parsing the source code, the processor may be further configured to: check the way fields are declared in the source code.

According to exemplary embodiments, wherein in identifying sensitive information data, the processor may be further configured to: apply the artificial intelligence or machine learning algorithm to identify words, phrases, and patterns from the source code that are known to be associated with confidential and sensitive information.

According to exemplary embodiments, wherein in automatically annotating the identified sensitive information data, the processor may be further configured to: mask, hash, not publish or encrypt the identified sensitive information data.

According to exemplary embodiments, wherein the processor may be further configured to: parse the source code to identify a field declaration; compare the identified field declaration with a list of prestored declarations known to be associated with confidential and sensitive information data; and output a result of comparison.

According to exemplary embodiments, the processor may be further configured to: determine that the result of comparison is a value that is less than a configurable threshold value; and determine that the identified field declaration does not include confidential and sensitive information data based on determining that the result of comparison is a value that is less than the configurable threshold value.

According to exemplary embodiments, the processor may be further configured to: determine that the result of comparison is a value that is equal to or more than the configurable threshold value; determine that the identified field declaration includes confidential and sensitive information data based on determining that the result of comparison is a value that is equal to or more than the configurable threshold value; and automatically identify variables that contain the identified field declaration as the identified sensitive information data.

According to yet another aspect of the present disclosure, a non-transitory computer readable medium configured to store instructions for automatically protecting sensitive information from being published, logged, or printed during an application compilation and/or deployment is disclosed. The instructions, when executed, may cause a processor to perform the following: receiving source code associated with an application being developed from a database or code editor; parsing the source code; identifying, in response to parsing, variables or fields in the source code that may include sensitive information data; applying artificial intelligence or machine learning algorithm to the source code to automatically identify variables that contain the sensitive information data based on the identified variables or fields and annotating accordingly, wherein each annotation is a hint that data associated with corresponding annotation is confidential and sensitive information that should not be published, logged, or printed; automatically updating the source code with the annotation; and automatically updating the database or code editor with the updated source code so that changes made to the source code would be permanently implemented during compiling and deploying of the application.

According to exemplary embodiments, in automatically annotating the identified sensitive information data, the instructions, when executed, may cause the processor to further perform the following: marking a field or data element in the source code; and stating that the marked field or the data element should not be written in plain text or any human readable format prior to or during compilation and/or deployment of the application, but the disclosure is not limited thereto.

According to exemplary embodiments, in parsing the source code, the instructions, when executed, may cause the processor to further perform the following: checking the way fields are declared in the source code.

According to exemplary embodiments, in identifying sensitive information data, the instructions, when executed, may cause the processor to further perform the following: applying the artificial intelligence or machine learning algorithm to identify words, phrases, and patterns from the source code that are known to be associated with confidential and sensitive information, but the disclosure is not limited thereto. For example, machine learning models can be generated by applying the artificial intelligence or machine learning algorithm to identify words, phrases, and patterns from the source code and the automated annotation injector module may be configured to implement pattern matching algorithms, dictionaries, e.g., corpora and lexical resources, etc., and natural language processing libraries to train the models.

According to exemplary embodiments, in automatically annotating the identified sensitive information data, the instructions, when executed, may cause the processor to further perform the following: masking, hashing, encrypting, not publishing the identified sensitive information data or otherwise making the identified sensitive information unreadable to humans, but the disclosure is not limited thereto.

According to exemplary embodiments, the instructions, when executed, may cause the processor to further perform the following: parsing the source code to identify a field declaration; comparing the identified field declaration with a list of prestored declarations known to be associated with confidential and sensitive information data; and outputting a result of comparison.

According to exemplary embodiments, the instructions, when executed, may cause the processor to further perform the following: determining that the result of comparison is a value that is less than a configurable threshold value; and determining that the identified field declaration does not include confidential and sensitive information data based on determining that the result of comparison is a value that is less than the configurable threshold value.

According to exemplary embodiments, the instructions, when executed, may cause the processor to further perform the following: determining that the result of comparison is a value that is equal to or more than the configurable threshold value; determining that the identified field declaration includes confidential and sensitive information data based on determining that the result of comparison is a value that is equal to or more than the configurable threshold value; and automatically annotating the identified field declaration as the identified sensitive information data.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform and language automated annotation injector module for automatically protecting sensitive information in accordance with an exemplary embodiment.

FIG. 2 illustrates an exemplary diagram of a network environment with a platform and language agnostic automated annotation injector device in accordance with an exemplary embodiment.

FIG. 3 illustrates a system diagram for implementing a platform and language agnostic automated annotation injector device having a platform and language agnostic automated annotation injector module in accordance with an exemplary embodiment.

FIG. 4 illustrates a system diagram for implementing a platform and language agnostic automated annotation injector module of FIG. 3 in accordance with an exemplary embodiment.

FIG. 5 illustrates an exemplary flow chart implemented by the platform and language agnostic automated annotation injector module of FIG. 4 for automatically protecting sensitive information in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

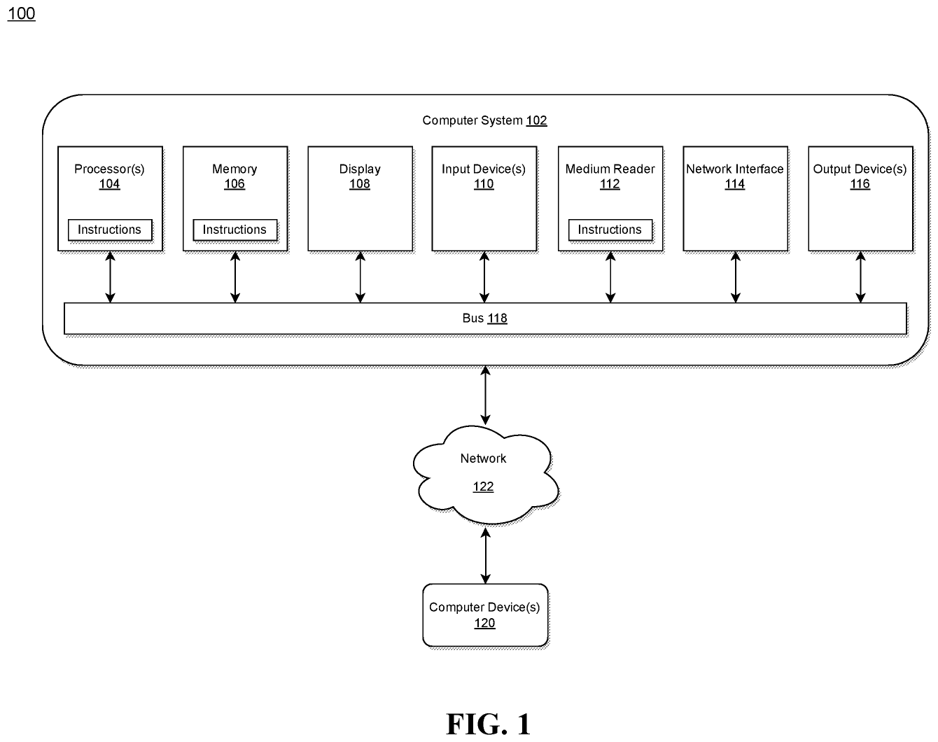

FIG. 1 is an exemplary system 100 for use in implementing a platform and language agnostic automated annotation injector module that may be configured for automatically injecting rules before an application is being compiled or deployed for protecting sensitive information from entering application logs, events, metrics, traces, or other outputs in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the automated annotation injector module may be platform and language agnostic that may allow for consistent easy orchestration and passing of data through various components to output a desired result. Since the disclosed process, according to exemplary embodiments, is platform and language agnostic, the automated annotation injector module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

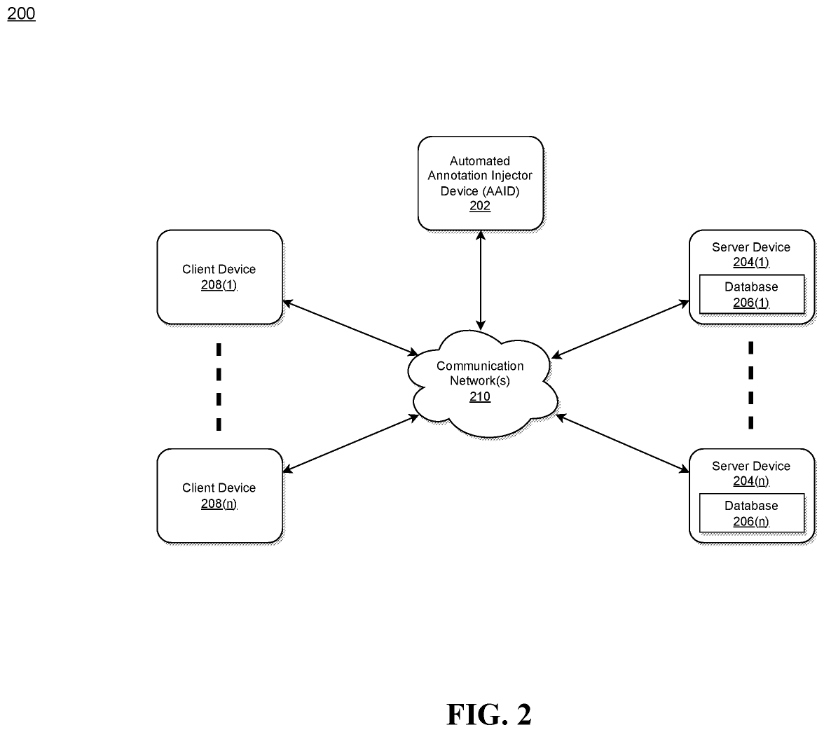

Referring to FIG. 2, a schematic of an exemplary network environment 200 for implementing a platform and language automated annotation injector device (AAID) of the instant disclosure is illustrated.

According to exemplary embodiments, the above-described problems associated with conventional tools may be overcome by implementing an AAID 202 as illustrated in FIG. 2 that may be configured for implementing a platform and language agnostic automated annotation injector module for automatically injecting rules before an application is being compiled or deployed for protecting sensitive information from entering application logs, events, metrics, traces, or other outputs, but the disclosure is not limited thereto.

The AAID 202 may be the same or similar to the computer system 102 as described with respect to FIG. 1.

The AAID 202 may store one or more applications that can include executable instructions that, when executed by the AAID 202, cause the AAID 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the AAID 202 itself, may be located in virtual server(s) running in a cloud-based computing environment rather than being tied to one or more specific physical network computing devices. Also, the application(s) may be running in one or more virtual machines (VMs) executing on the AAID 202. Additionally, in one or more embodiments of this technology, virtual machine(s) running on the AAID 202 may be managed or supervised by a hypervisor.

In the network environment 200 of FIG. 2, the AAID 202 is coupled to a plurality of server devices 204(1)-204(n) that hosts a plurality of databases 206(1)-206(n), and also to a plurality of client devices 208(1)-208(n) via communication network(s) 210. A communication interface of the AAID 202, such as the network interface 114 of the computer system 102 of FIG. 1, operatively couples and communicates between the AAID 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AAID 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The AAID 202 may be a standalone device or integrated with one or more other devices or apparatuses, such as one or more of the server devices 204(1)-204(n), for example. In one particular example, the AAID 202 may be hosted by one of the server devices 204(1)-204(n), and other arrangements are also possible. Moreover, one or more of the devices of the AAID 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the AAID 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the AAID 202 that may efficiently provide a platform for implementing a platform and language agnostic automated annotation injector module for automatically injecting rules before an application is being compiled for protecting sensitive information from entering application logs, events, metrics, traces, or other outputs, but the disclosure is not limited thereto.

The client devices 208(1)-208(n) may run interface applications, such as standard web browsers or standalone client applications, which may provide an interface to communicate with the AAID 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the AAID 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the AAID 202, the server devices 204(1)-204(n), or the client devices 208(1)-208(n), for example, may be configured to operate as virtual instances on the same physical machine. For example, one or more of the AAID 202, the server devices 204(1)-204(n), or the client devices 208(1)-208(n) may operate on the same physical device rather than as separate devices communicating through communication network(s) 210. Additionally, there may be more or fewer AAIDs 202, server devices 204(1)-204(n), or client devices 208(1)-208(n) than illustrated in FIG. 2. According to exemplary embodiments, the AAID 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

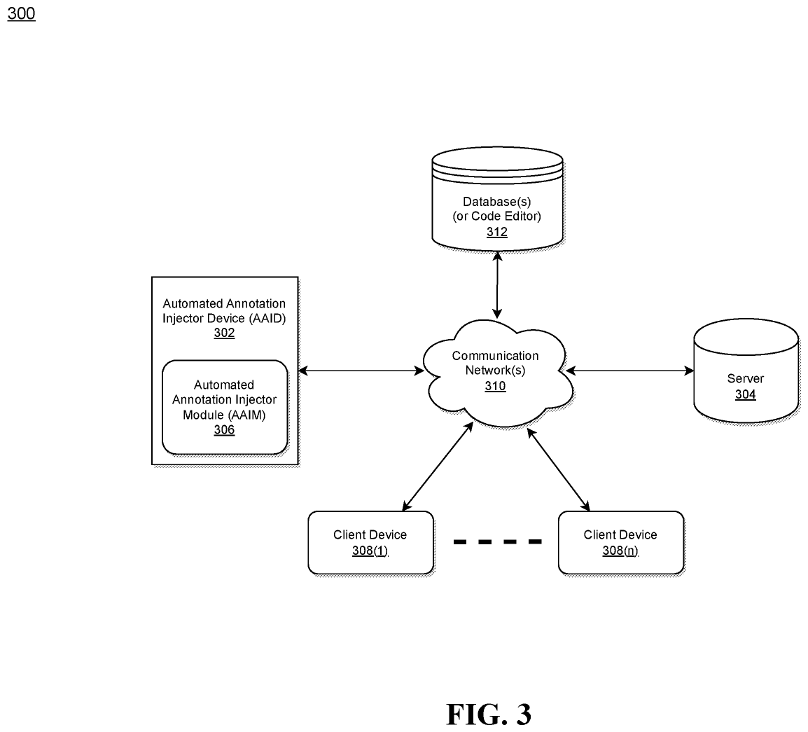

FIG. 3 illustrates a system diagram for implementing an AAID having a platform and language agnostic automated annotation injector module (AAIM) in accordance with an exemplary embodiment.

As illustrated in FIG. 3, the system 300 may include an AAID 302 within which an AAIM 306 is embedded, a server 304, a database(s) 312 (or a code editor), a plurality of client devices 308(1) . . . 308(n), and a communication network 310.

According to exemplary embodiments, the AAID 302 including the AAIM 306 may be connected to the server 304, and the database(s) 312 (or the code editor) via the communication network 310. The AAID 302 may also be connected to the plurality of client devices 308(1) . . . 308(n) via the communication network 310, but the disclosure is not limited thereto.

According to exemplary embodiment, the AAID 302 is described and shown in FIG. 3 as including the AAIM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) may be a mainframe database, a log database that may produce programming for searching, monitoring, and analyzing machine-generated data via a web interface, etc., but the disclosure is not limited thereto.

According to exemplary embodiments, the AAIM 306 may be configured to receive real-time feed of data from the plurality of client devices 308(1) . . . 308(n) via the communication network 310.

As will be described below, the AAIM 306 may be configured to: receive source code associated with an application being developed from a database or code editor; parse the source code; identify, in response to parsing, variables or fields in the source code that include sensitive information data; apply artificial intelligence or machine learning algorithm to the source code to automatically identify variables that contain the sensitive information data based on the identified variables or fields, wherein each annotation is a hint that data associated with corresponding annotation is confidential and sensitive information that should not be published, logged, or printed; automatically update the source code with the annotation; and automatically update the database or code editor with the updated source code so that changes made to the source code would be permanently implemented during compiling and deploying of the application, but the disclosure is not limited thereto.

The plurality of client devices 308(1) . . . 308(n) are illustrated as being in communication with the AAID 302. In this regard, the plurality of client devices 308(1) . . . 308(n) may be “clients” (e.g., customers) of the AAID 302 and are described herein as such. Nevertheless, it is to be known and understood that the plurality of client devices 308(1) . . . 308(n) need not necessarily be “clients” of the AAID 302, or any entity described in association therewith herein. Any additional or alternative relationship may exist between either or both of the plurality of client devices 308(1) . . . 308(n) and the AAID 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the AAID 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The AAID 302 may be the same or similar to the AAID 202 as described with respect to FIG. 2, including any features or combination of features described with respect thereto.

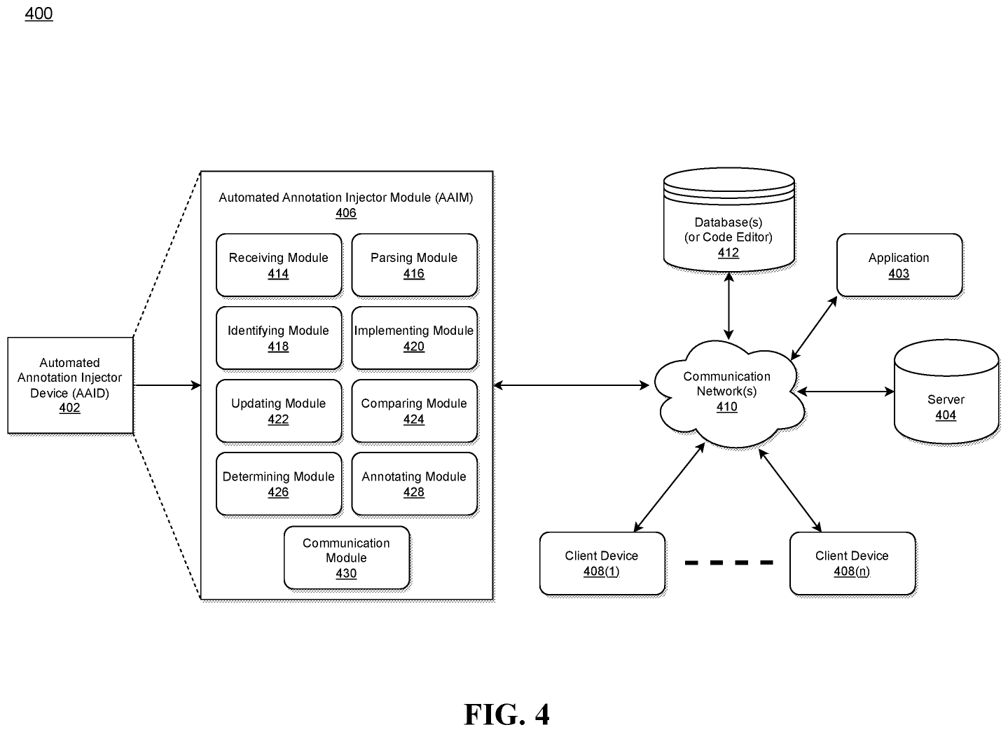

FIG. 4 illustrates a system diagram for implementing an AAIM of FIG. 3 in accordance with an exemplary embodiment.

According to exemplary embodiments, the system 400 may include a platform and language agnostic AAID 402 within which a platform and language agnostic AAIM 406 is embedded, an application 403, a server 404, database(s) 412 (or a code editor), and a communication network 410.

According to exemplary embodiments, the AAID 402 including the AAIM 406 may be connected to the application 403, the server 404, and the database(s) 412 (or the code editor) via the communication network 410. The AAID 402 may also be connected to the plurality of client devices 408(1)-408(n) via the communication network 410, but the disclosure is not limited thereto. The AAIM 406, the server 404, the plurality of client devices 408(1)-408(n), the database(s) 412, the communication network 410 as illustrated in FIG. 4 may be the same or similar to the AAIM 306, the server 304, the plurality of client devices 308(1)-308(n), the database(s) 312 (or the code editor), the communication network 310, respectively, as illustrated in FIG. 3.

According to exemplary embodiments, as illustrated in FIG. 4, the AAIM 406 may include a receiving module 414, a parsing module 416, an identifying module 418, an implementing module 420, an updating module 422, a comparing module 424, a determining module 426, an annotating module 428, and a communication module 430. According to exemplary embodiments, interactions and data exchange among these modules included in the AAIM 406 and the application 403 provide the advantageous effects of the disclosed invention. Functionalities of each module of FIG. 4 will be described in detail below.

According to exemplary embodiments, each of the receiving module 414, parsing module 416, identifying module 418, implementing module 420, updating module 422, comparing module 424, determining module 426, annotating module 428, and the communication module 430 of the AAIM 406 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the receiving module 414, parsing module 416, identifying module 418, implementing module 420, updating module 422, comparing module 424, determining module 426, annotating module 428, and the communication module 430 of the AAIM 406 may be implemented by microprocessors or similar, and may be programmed using software (e.g., microcode) to perform various functions discussed herein and may optionally be driven by firmware and/or software.

Alternatively, according to exemplary embodiments, each of the receiving module 414, parsing module 416, identifying module 418, implementing module 420, updating module 422, comparing module 424, determining module 426, annotating module 428, and the communication module 430 of the AAIM 406 may be implemented by dedicated hardware, or as a combination of dedicated hardware to perform some functions and a processor (e.g., one or more programmed microprocessors and associated circuitry) to perform other functions.

According to exemplary embodiments, each of the receiving module 414, parsing module 416, identifying module 418, implementing module 420, updating module 422, comparing module 424, determining module 426, annotating module 428, and the communication module 430 of the AAIM 406 may be called via corresponding API.

The process may be executed via the communication module 430 and the communication network 410, which may comprise plural networks as described above. For example, in an exemplary embodiment, the various components of the AAIM 406 may communicate with the server 404, and the database(s) 412 via the communication module 430 and the communication network 410. Of course, these embodiments are merely exemplary and are not limiting or exhaustive.

According to exemplary embodiments, the receiving module 414 may be configured to receive source code associated with the application 403 being developed from the database(s) 412 (i.e., code repository). The parsing module 416 may be configured to parse the source code obtained from the database(s) 412. The identifying module 418 may be configured to identify, in response to parsing, variables or fields in the source code that may include sensitive information data. The implementing module 420 may be configured to apply artificial intelligence or machine learning algorithm to the source code to automatically identify variables that contain (by utilizing the annotation module 428) the sensitive information data based on the identified variables or fields. According to exemplary embodiments, each annotation may be a hint that the data associated with corresponding annotation is confidential and sensitive information that should not be published, logged, printed, or outputted in other forms. The updating module 422 may be configured to automatically update the source code with the annotation. The updating module 422 may be further configured to automatically update the database(s) 412 with the updated source code so that changes made to the source code would be permanently implemented during compiling and/or deploying of the application 403.

According to exemplary embodiments, the sensitive information data may include one or more of the following data name, address, phone number, social security number, credit card information, bank account, email address, customer spending data, and automated teller machine usage data, etc., but the disclosure is not limited thereto.

According to exemplary embodiments, in automatically annotating the identified sensitive information data, and the annotating module 428 may be further configured to: mark a field or data element in the source code; and state that the marked field or the data element should not be written in plain text or any human readable format prior to or during compilation and/or deployment of the application, but the disclosure is not limited thereto.

According to exemplary embodiments, in parsing the source code, the parsing module 416 may be configured to check the way fields are declared in the source code.

According to exemplary embodiments, in identifying sensitive information data, the implementing module 420 may be further configured to apply the artificial intelligence or machine learning algorithm to identify words, phrases, and patterns from the source code that are known to be associated with confidential and sensitive information, but the disclosure is not limited thereto. For example, machine learning models can be generated by applying the artificial intelligence or machine learning algorithm to identify words, phrases, and patterns from the source code, and the AAIM 406 may be configured to implement pattern matching algorithms, dictionaries, e.g., corpora and lexical resources, etc., and natural language processing (NLP) libraries to train these models. In NLP, large bodies of linguistic data, or corpora are typically used. According to exemplary embodiments, corpora may be designed to contain a careful balance of material in one or more genres. As utilized within scope of the present disclosure, NLP is a branch of artificial intelligence that enables machines to understand the human language. According to exemplary embodiments, the AAIM 406 may be configured to build systems that can make sense of text and automatically perform tasks like translation, spell check, or topic classification in identifying sensitive information data.

According to exemplary embodiments, in automatically annotating the identified sensitive information data, and the annotating module 428 may be further configured to mask, hash, encrypt, not publish the identified sensitive information data or otherwise making the identified sensitive information unreadable to humans, but the disclosure is not limited thereto.

According to exemplary embodiments, the parsing module 416 may be configured to parsing the source code to identify a field declaration; the comparing module 424 may be configured to compare the identified field declaration with a list of prestored declarations (may be prestored onto the database(s) 412) known to be associated with confidential and sensitive information data and output a result of comparison.

According to exemplary embodiments, the determining module 426 may be configured to determine that the result of comparison is a value that is less than a configurable threshold value; and determine that the identified field declaration does not include confidential and sensitive information data based on determining that the result of comparison is a value that is less than the configurable threshold value.

According to exemplary embodiments, the determining module 426 may be further configured to determine that the result of comparison is a value that is equal to or more than the configurable threshold value; determine that the identified field declaration includes confidential and sensitive information data based on determining that the result of comparison is a value that is equal to or more than the configurable threshold value; and automatically identify variables that contain, by utilizing the annotating module 428 the identified field declaration as the identified sensitive information data.

According to exemplary embodiments, the AAIM 406 may be configured to automatically inject rules before an application is being compiled for protecting sensitive data that may include PI, PII, CI, HCl, and other sensitive data from entering application logs, events, metrics, traces, or other outputs, but the disclosure is not limited thereto.

According to exemplary embodiments, the AAIM 406 implements information confidentiality classification levels utilized by an organization that may include (in order of increasing sensitivity): public information; internal information; CI; HCl, but the disclosure is not limited thereto. Classification of information may be based on each element's confidentiality. The information confidentiality classification level must increase when elements are combined with a direct identifier (i.e., corporation brand names, email addresses of any individual which is widely disseminated or publicly available, personal photograph of an individual which is widely disseminated or publicly available, etc.), or may increase as other factors are considered. That is, direct identifier is an element that explicitly includes the name of a person or an institution, or from which the name can be obviously derived (e.g., a Social Security number).

According to exemplary embodiments, the AAIM 406 may establish appropriate volume thresholds within a classification which enable designated controls to be optional for that classification. As examples, a line of business (LOB) or corporate function (CF) may set thresholds for low volumes of confidential PI, so that an email does not have to be encrypted, or low volumes of employee security identifiers where the third party oversight risk category could be reduced. These volume thresholds are approved by an authoritative office, i.e., a company's global privacy office.

According to exemplary embodiments, the PI, PIE, CI, HCl, and other sensitive data are not public information. Public information is information that is publicly available or widely disseminated. Such information has not been obtained by an organization under an expectation of confidentiality. Unauthorized access or disclosure of this information does not expose the organization (including its employees, clients, or suppliers) or individuals to financial loss or reputational harm and does not reasonably jeopardize the security of physical or information resources.

According to exemplary embodiments, PI, PII, and CCI are rarely classified as public information and must not be classified as such unless they clearly and unambiguously meet the above definition of public information. Examples of public information may include, but not limited thereto: Employee or customer contact information which is publicly available and was not obtained under an expectation of confidentiality; published company switchboard and customer helpdesk numbers; published annual reports; published company physical and postal addresses for client facing premises (e.g., major offices and branches of an organization/company); marketing information made available to the public describing company products and services; information approved for publication on company public websites (e.g., profiles of the company leadership team); public announcements approved for release by media relations; regulatory agency reports specified by the regulator as public; public keys used in asymmetric encryption schemes; information obtained from public sources where no regulatory or contractual obligation of confidentiality exists, etc.

According to exemplary embodiments, internal information is information that is required to perform company day-to-day work and may be accessed broadly by workforce members. Internal information may also be shared with vendors, consultants, and other parties with appropriate contractual arrangements. Unauthorized access or disclosure of this information, while undesirable, typically does not pose a high risk and does not carry significant financial, reputational, or regulatory consequences. Examples of internal information may include, but not limited thereto: employee contact information; information approved for publication on the general corporate intranet (e.g., company home, workplace resources) by corporate and/or LOB; communications; organizational announcements and charts; company physical and postal addresses for data centers and other non-client-facing offices or facilities; corporate policies, standards and operating procedures; information resources for workforce members, etc.

According to exemplary embodiments, CI is information that carries a regulatory and/or contractual expectation of confidentiality, and/or has limited distribution on a need-to-know basis. Unauthorized access or disclosure of such information can result in adverse financial, reputational, or regulatory consequences if mishandled. Some CI elements may become HCl when they are linked to a direct identifier as disclosed above. Examples of Confidential information may include, but not limited thereto: employee or customer contact information which carries an expectation of confidentiality (e.g., age); balance sheets, profit and loss figures, firm-owned holdings, country exposure, general ledger, legal files and similar information; internal and external audit reports; company's data center locations; information revealing the firm's security and controls environment, including (but not limited to) reports, scorecards and metrics produced by Information Technology Risk & Security Management; funds transfer/transaction information; intellectual property; regulatory agency reports, not specified by the regulator as public or not defined as confidential supervisory information; business continuity and disaster recovery plans (unless the content includes HCl elements); information that the one who manages most aspects of the information resource designates as confidential (e.g. information considered to have potential for providing competitive advantage), etc.

According to exemplary embodiments, HCl is information that can result in serious financial, reputational, or regulatory consequences if mishandled. Unauthorized access or disclosure of such data to unauthorized parties could compromise business secrets, jeopardize company's obligations to clients and regulators, trigger customer notification requirements (i.e., breach reporting), or present a significant increased risk of identity theft or fraud. Examples of Highly Confidential information my include, but not limited thereto: Sensitive Personal Information (SPI); Material Non Public Information (MNPI); information revealing details of security incidents; passwords and authentication credentials; security keys (e.g., encryption keys); Confidential Supervisory Information (CSI), etc.

According to exemplary embodiments, SPI may include personal information relating to an individual that includes (1) racial or ethnic origin; (2) political opinions; (3) religious or philosophical beliefs; (4) membership in a trade union; (5) physical or mental health condition; (6) sexual life (7) biometric data or genetic data; or (8) alleged criminal acts, ongoing criminal or administrative proceedings or the results of past proceedings, or such other information as may be defined under applicable law, but the disclosure is not limited thereto.

Exemplary other factors impacting confidentiality classification may include, but not limited thereto, the following factors as illustrated in Table 1 below.

TABLE 1

| | | | | Highly |
|---|---|---|---|---|
| | | | Confidential | Confidential |
| | Public | Internal | Information | Information |
| Factor | Information | Information | (CI) | (HCI) |
| Jeopardize | Public | Corporate | Business | Information |
| Important | announcement | policies | Continuity | revealing |
| Interests | surrounding | relating to | Report | security details |
| (security | compromise to | components of | | |
| incident) | firm | the compromise | | |
| Compromise | Website for | Details of who | General ledger | Financial |
| Business | public which | performs the | | forecasting |
| Secrets | describes | forecasting | | |
| (MNPI) | forecasting | | | |
| | group | | | |
| Highly | Photograph | Photograph | Photograph | Photograph |
| Sensitive to | available on | available on the | received under | which allows |
| individual | social media | intranet | expectation of | biometric |
| (SPI) | | | confidentiality | analysis of the |
| | | | | individual |
| Risk of Fraud | Person posts on | Person mentions | Financial | Password for |
| or | publicly | they bank with | account | financial |
| Identity Theft | available site | the company on | | account |
| (password) | that they bank at | webcast | | |
| | the company | available to | | |
| | | whole firm | | |
| Customer | Public | Announcement | Individual | First name and |
| Notification | Announcement | in the company | customer's first | driver's license |
| Requirements | that vendor had | that vendor had | name | number |
| | breach | breach | | |
| Regulatory | Public article | Company Anti- | Information | The entire |
| Consequences | about arrest of | Money | pertaining to an | Know Your |
| | an individual | Laundering | individual in a | Customer |
| | | Policies | Know Your | Record |
| | | | Customer | |
| | | | Record | |

According to exemplary embodiments, the AAIM 406 may be configured to. provide utilities for sending object (i.e., Plain Old Java Object (POJO) in PI and/or PII safe manner, but the disclosure is not limited thereto. For example, the AAIM 406 may utilize a formatter to implement toString( ) JavaScript which honors the annotation, but the disclosure is not limited to JAVA. According to exemplary embodiments, the overloaded formatter accepts format strings and honors the annotations.

According to exemplary embodiments, the AAIM 406 may be configured to provide code scanning definitions and refactoring plugins. For example, the AAIM 406 may implement a code quality scanner to automatically detect candidate code; identify at risk code. A user may use plugin to refactor code to become PI or PII complaint. The plugin tests code before and after for correctness.

According to exemplary embodiments, the AAIM 406 may be configured to provide fillers on logging tools that honor PI or PH annotations, i.e., a logger becomes annotation aware and processes POJO in PI or PII safe manner as guided by the annotations.

According to exemplary embodiments, the AAIM 406 may be configured to provide capability to switch between opt in/opt out on hash/masking data; reflect compliance via reporting dashboard; reporting of code changed, # of annotations installed; automate onboarding validation of capability; leverage build pipelines, i.e., addressing those not using framework, but the disclosure is not limited thereto.

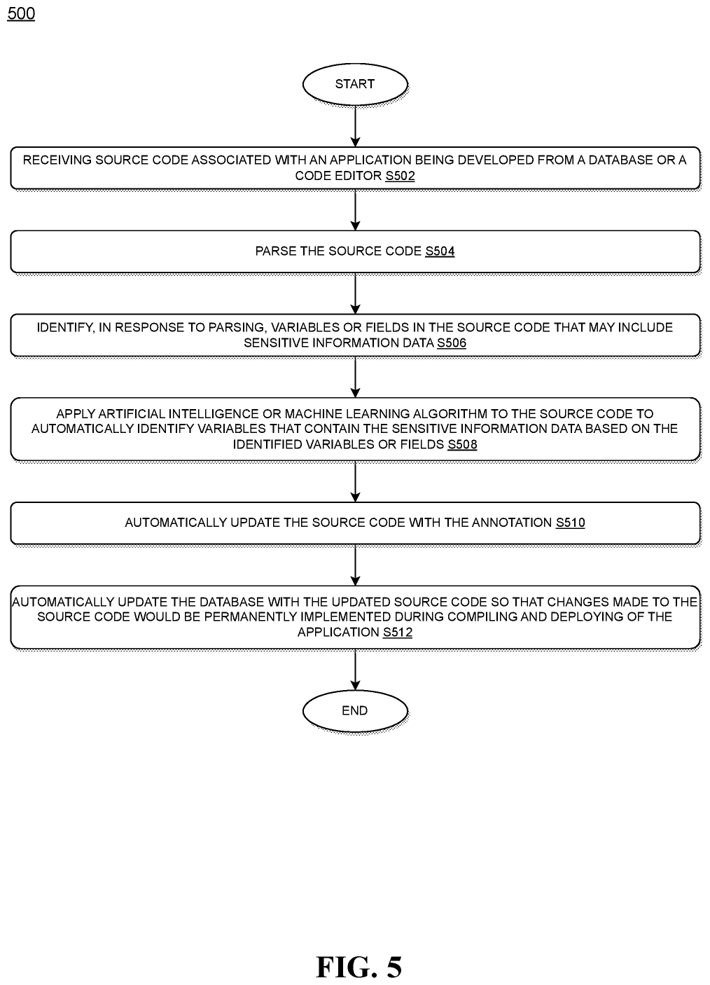

FIG. 5 illustrates an exemplary flow chart 500 implemented by the AAIM 405 of FIG. 4 for automatically protecting sensitive information from being published, logged, or printed during an application compilation and/or deployment in accordance with an exemplary embodiment. It will be appreciated that the illustrated process 500 and associated steps may be performed in a different order, with illustrated steps omitted, with additional steps added, or with a combination of reordered, combined, omitted, or additional steps.

As illustrated in FIG. 5, at step S502, the process 500 may include receiving source code associated with an application being developed from a database or code editor.

At step S504, the process 500 may include parsing the source code.

At step S506, the process 500 may include identifying, in response to parsing, variables or fields in the source code that may include sensitive information data.

At step S508, the process 500 may include applying artificial intelligence or machine learning algorithm to the source code to automatically detect identified variables or fields that may contain sensitive information and annotating accordingly.

At step S510, the process 500 may include automatically updating the source code with the annotation. Each annotation is a hint that data associated with corresponding annotation is confidential and sensitive information that should not be published, logged, or printed.

At step S512, the process 500 may include automatically updating the database or code editor with the updated source code so that changes made to the source code would be permanently implemented during compiling and deploying of the application.

According to exemplary embodiments, in automatically annotating the identified sensitive information data, and the process 500 may further include: marking a field or data element in the source code; and stating that the marked field or the data element should not be written in plain text or any human readable format prior to or during compilation and/or deployment of the application, but the disclosure is not limited thereto.

According to exemplary embodiments, in parsing the source code, the process 500 may further include: checking the way fields are declared in the source code.

According to exemplary embodiments, in identifying sensitive information data, the process 500 may further include: applying the artificial intelligence or machine learning algorithm to identify words, phrases, and patterns from the source code that are known to be associated with confidential and sensitive information.

According to exemplary embodiments, in automatically annotating the identified sensitive information data, and the process 500 may further include: masking, hashing, encrypting, not publishing the identified sensitive information data or otherwise making the sensitive information unreadable to humans, but the disclosure is not limited thereto.

According to exemplary embodiments, the process 500 may further include: parsing the source code to identify a field declaration; comparing the identified field declaration with a list of prestored declarations known to be associated with confidential and sensitive information data; and outputting a result of comparison.

According to exemplary embodiments, the process 500 may further include: determining that the result of comparison is a value that is less than a configurable threshold value; and determining that the identified field declaration does not include confidential and sensitive information data based on determining that the result of comparison is a value that is less than the configurable threshold value.

According to exemplary embodiments, the process 500 may further include: determining that the result of comparison is a value that is equal to or more than the configurable threshold value; determining that the identified field declaration includes confidential and sensitive information data based on determining that the result of comparison is a value that is equal to or more than the configurable threshold value; and automatically annotating the identified field declaration as the identified sensitive information data.

According to exemplary embodiments, the AAID 402 may include a memory (e.g., a memory 106 as illustrated in FIG. 1) which may be a non-transitory computer readable medium that may be configured to store instructions for implementing a platform and language agnostic AAIM 406 for automatically injecting rules before an application is being compiled or deployed for protecting sensitive information from entering application logs, events, metrics, traces, or other outputs as disclosed herein. The AAID 402 may also include a medium reader (e.g., a medium reader 112 as illustrated in FIG. 1) which may be configured to read any one or more sets of instructions, e.g., software, from any of the memories described herein. The instructions, when executed by a processor embedded within the AAIM 406, 506 or within the AAID 402, may be used to perform one or more of the methods and processes as described herein. In a particular embodiment, the instructions may reside completely, or at least partially, within the memory 106, the medium reader 112, and/or the processor 104 (see FIG. 1) during execution by the AAID 402.

According to exemplary embodiments, the instructions, when executed, may cause a processor embedded within the AAIM 406 or the AAID 402 to perform the following: receiving source code associated with an application being developed from a database or code editor; parsing the source code; identifying, in response to parsing, variables or fields in the source code that may include sensitive information data; applying artificial intelligence or machine learning algorithm to the source code to automatically identify variables that contain the sensitive information data based on the identified variables or fields, wherein each annotation is a hint that data associated with corresponding annotation is confidential and sensitive information that should not be published, logged, or printed; automatically updating the source code with the annotation; and automatically updating the database or code editor with the updated source code so that changes made to the source code would be permanently implemented during compiling and deploying of the application. According to exemplary embodiments, the processor may be the same or similar to the processor 104 as illustrated in FIG. 1 or the processor embedded within AAID 202, AAID 302, AAID 402, and AAIM 406, 506.

According to exemplary embodiments, in automatically annotating the identified sensitive information data, the instructions when executed may further cause the processor 104 to perform the following: marking a field or data element in the source code; and stating that the marked field or the data element should not be written in plain text or any human readable format prior to or during compilation and/or deployment of the application.

According to exemplary embodiments, in parsing the source code, the instructions when executed may further cause the processor 104 to perform the following: checking the way fields are declared in the source code.

According to exemplary embodiments, in identifying sensitive information data, the instructions when executed may further cause the processor 104 to perform the following: applying the artificial intelligence or machine learning algorithm to identify words, phrases, and patterns from the source code that are known to be associated with confidential and sensitive information, but the disclosure is not limited thereto. For example, machine learning models can be generated by applying the artificial intelligence or machine learning algorithm to identify words, phrases, and patterns from the source code, and the processor 104 may be configured to implement pattern matching algorithms, dictionaries, e.g., corpora and lexical resources, etc., and natural language processing libraries to train these models.

For example, the processor 104 may implement pattern matching algorithms, dictionaries, e.g., corpora and lexical resources, etc., and natural language processing libraries to train the models.

According to exemplary embodiments, in automatically annotating the identified sensitive information data, the instructions when executed may further cause the processor 104 to perform the following: masking, hashing, encrypting, not publishing the identified sensitive information data or otherwise making the identified sensitive information data unreadable to humans, but the disclosure is not limited thereto.

According to exemplary embodiments, the instructions when executed may further cause the processor 104 to perform the following: parsing the source code to identify a field declaration; comparing the identified field declaration with a list of prestored declarations known to be associated with confidential and sensitive information data; and outputting a result of comparison.

According to exemplary embodiments, the instructions when executed may further cause the processor 104 to perform the following: determining that the result of comparison is a value that is less than a configurable threshold value; and determining that the identified field declaration does not include confidential and sensitive information data based on determining that the result of comparison is a value that is less than the configurable threshold value.

According to exemplary embodiments, the instructions when executed may further cause the processor 104 to perform the following: determining that the result of comparison is a value that is equal to or more than the configurable threshold value; determining that the identified field declaration includes confidential and sensitive information data based on determining that the result of comparison is a value that is equal to or more than the configurable threshold value; and automatically annotating the identified field declaration as the identified sensitive information data.

According to exemplary embodiments as disclosed above in FIGS. 1-5, technical improvements effected by the instant disclosure may include a platform for implementing a platform and language agnostic automated annotation injector module for automatically injecting rules before an application is being compiled for protecting sensitive information from entering application logs, events, metrics, traces, or other outputs, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for protecting sensitive information by utilizing one or more processors along with allocated memory, the method comprising:
receiving source code associated with an application being developed from a database or a code editor;
parsing the source code;
identifying, in response to parsing, variables or fields in the source code that include sensitive information data;
applying artificial intelligence or machine learning algorithm to the source code to automatically identify variables that contain the sensitive information data based on the identified variables or fields and annotating accordingly, wherein each annotation is a hint that data associated with corresponding annotation is confidential and sensitive information that should not be published, logged, or printed;
automatically updating the source code with the annotation; and
automatically updating the database or the code editor with the updated source code so that changes made to the source code would be permanently implemented during compiling and deploying of the application.

2. The method according to claim 1, wherein the sensitive information data includes one or more of the following data: name, address, phone number, social security number, credit card information, bank account, email address, customer spending data, customer health data, automated teller machine usage data, customer location data, trading positions, employee information data, and sensitive company data.

3. The method according to claim 1, wherein in automatically annotating the identified sensitive information data, and the method further comprising:
marking a field or data element in the source code; and
stating that the marked field or the data element should not be written in plain text or any human readable format prior to or during compilation and/or deployment of the application.

4. The method according to claim 1, wherein in parsing the source code, the method further comprising:
checking the way fields are declared in the source code.

5. The method according to claim 1, wherein in identifying sensitive information data, the method further comprising:
applying the artificial intelligence or machine learning algorithm to identify words, phrases, and patterns from the source code that are known to be associated with confidential and sensitive information.

6. The method according to claim 1, wherein in automatically annotating the identified sensitive information data, and the method further comprising:
masking, hashing, not publishing or encrypting the identified sensitive information data.

7. The method according to claim 1, further comprising:
parsing the source code to identify a field declaration;
comparing the identified field declaration with a list of prestored declarations known to be associated with confidential and sensitive information data; and
outputting a result of comparison.

8. The method according to claim 7, further comprising:
determining that the result of comparison is a value that is less than a configurable threshold value; and
determining that the identified field declaration does not include confidential and sensitive information data based on determining that the result of comparison is a value that is less than the configurable threshold value.

9. The method according to claim 7, further comprising:
determining that the result of comparison is a value that is equal to or more than the configurable threshold value;
determining that the identified field declaration includes confidential and sensitive information data based on determining that the result of comparison is a value that is equal to or more than the configurable threshold value; and
automatically annotating the identified field declaration as the identified sensitive information data.

10. A system for protecting sensitive information, the system comprising:
a processor; and
a memory operatively connected to the processor via a communication interface, the memory storing computer readable instructions, when executed, causes the processor to:
receive source code associated with an application being developed from a database or a code editor;
parse the source code;
identify, in response to parsing, variables or fields in the source code that include sensitive information data;
apply artificial intelligence or machine learning algorithm to the source code to automatically identify variables that contain the sensitive information data based on identifying the variables or fields and annotate accordingly, wherein each annotation is a hint that data associated with corresponding annotation is confidential and sensitive information that should not be published, logged, or printed;
automatically update the source code with the annotation; and
automatically update the database or the code editor with the updated source code so that changes made to the source code would be permanently implemented during compiling and deploying of the application.

11. The system according to claim 10, wherein the sensitive information data includes one or more of the following data: name, address, phone number, social security number, credit card information, bank account, email address, customer spending data, customer health data, automated teller machine usage data, customer location data, trading positions, employee information data, and sensitive company data.

12. The system according to claim 10, wherein in automatically annotating the identified sensitive information data, and the processor is further configured to:
mark a field or data element in the source code; and
state that the marked field or the data element should not be written in plain text or any human readable format prior to or during compilation and/or deployment of the application.

13. The system according to claim 10, wherein in parsing the source code, the processor is further configured to:
check the way fields are declared in the source code.

14. The system according to claim 10, wherein in identifying sensitive information data, the processor is further configured to:
apply the artificial intelligence or machine learning algorithm to identify words, phrases, and patterns from the source code that are known to be associated with confidential and sensitive information.

15. The system according to claim 10, wherein in automatically annotating the identified sensitive information data, the processor is further configured to:
mask, hash, not publish or encrypt the identified sensitive information data.

16. The system according to claim 10, wherein the processor is further configured to:
parse the source code to identify a field declaration;
compare the identified field declaration with a list of prestored declarations known to be associated with confidential and sensitive information data; and
output a result of comparison.

17. The system according to claim 16, the processor is further configured to:
determine that the result of comparison is a value that is less than a configurable threshold value; and
determine that the identified field declaration does not include confidential and sensitive information data based on determining that the result of comparison is a value that is less than the configurable threshold value.

18. The system according to claim 16, the processor is further configured to:
determine that the result of comparison is a value that is equal to or more than the configurable threshold value;
determine that the identified field declaration includes confidential and sensitive information data based on determining that the result of comparison is a value that is equal to or more than the configurable threshold value; and
automatically identify variables that contain the identified field declaration as the identified sensitive information data.

19. A non-transitory computer readable medium configured to store instructions for protecting sensitive information, wherein, when executed, the instructions cause a processor to perform the following:
receiving source code associated with an application being developed from a database or a code editor;
parsing the source code;
identifying, in response to parsing, variables or fields in the source code that include sensitive information data;
applying artificial intelligence or machine learning algorithm to the source code to automatically identify variables that contain the sensitive information data based on the identified variables or fields and annotating accordingly, wherein each annotation is a hint that data associated with corresponding annotation is confidential and sensitive information that should not be published, logged, or printed;
automatically updating the source code with the annotation; and
automatically updating the database or the code editor with the updated source code so that changes made to the source code would be permanently implemented during compiling and deploying of the application.

20. The non-transitory computer readable medium according to claim 19, wherein the sensitive information data includes one or more of the following data: name, address, phone number, social security number, credit card information, bank account, email address, customer spending data, customer health data, automated teller machine usage data, customer location data, trading positions, employee information data, and sensitive company data.
